(19) United States
(12) Patent Application Publication
(10) Pub. No.: US 2025/0365522 A1
(43) Pub. Date: Nov. 27, 2025

(54) PHOTOELECTRIC CONVERSION DEVICE AND PHOTOELECTRIC CONVERSION SYSTEM

(71) Applicant: CANON KABUSHIKI KAISHA, Tokyo (JP)

(72) Inventors: HIDEO KOBAYASHI, Tokyo (JP); MASANORI FURUTA, Kanagawa (JP)

(21) Appl. No.: 19/211,835

(22) Filed: May 19, 2025

(30) Foreign Application Priority Data
May 24, 2024 (JP) 2024-084613

(51) Int. Cl. H04N 25/78; H04N 25/709; H04N 25/771; H04N 25/778; H04N 25/79

(52) U.S. Cl. CPC H04N 25/78; H04N 25/709; H04N 25/778; H04N 25/79; H04N 25/771

(57) ABSTRACT

A photoelectric conversion device includes a pixel including a photoelectric conversion unit and an output unit configured to output a signal based on charge generated in the photoelectric conversion unit, a signal output line connected to the pixel, a level shift circuit connected to the signal output line and configured to perform a level-shift on an output signal of the pixel in a direction in which a voltage decreases, and a signal processing circuit connected to the level shift circuit and including a capacitor to which an output signal of the level shift circuit is input. The signal processing circuit includes an oversampling-type analog-to-digital conversion circuit.

### BACKGROUND

### Field of the Technology

The present disclosure relates to a photoelectric conversion device and a photoelectric conversion system.

### Description of the Related Art

In a photoelectric conversion device such as a CMOS image sensor, signal processing such as predetermined amplification processing or analog-to-digital conversion processing is performed on a pixel signal output from each column of a pixel array in a column circuit provided corresponding to each column. Japanese Patent Laid-Open No. 2019-030002 describes a solid-state imaging device including a column circuit including an analog-to-digital conversion circuit and an amplifier circuit.

As the scale of the pixel array increases, the circuit scale of the peripheral circuit including the column circuits also increases. Therefore, from the viewpoint of reduction in chip area and power consumption of the photoelectric conversion device, reduction in area and power consumption of the column circuits are also required.

### SUMMARY

The present disclosure is directed to provide a photoelectric conversion device and a photoelectric conversion system capable of realizing a smaller chip area and lower power consumption.

According to an aspect of the present disclosure, there is provided a photoelectric conversion device including a pixel including a photoelectric conversion unit and an output unit configured to output a signal based on charge generated in the photoelectric conversion unit, a signal output line connected to the pixel, a level shift circuit connected to the signal output line and configured to perform a level-shift on an output signal of the pixel in a direction in which a voltage decreases, and a signal processing circuit connected to the level shift circuit and including a capacitor to which an output signal of the level shift circuit is input, wherein the signal processing circuit includes an oversampling-type analog-to-digital conversion circuit.

Further features of the present disclosure will become apparent from the following description of exemplary embodiments with reference to the attached drawings. The following description of embodiments are described by way of example.

### BRIEF DESCRIPTION OF THE DRAWINGS

FIG. 1 is a block diagram illustrating a schematic configuration of a photoelectric conversion device according to a first embodiment.

FIG. 2 is a circuit diagram illustrating a configuration example of a pixel in the photoelectric conversion device according to the first embodiment.

FIG. 3 is a circuit diagram illustrating a configuration example of a column circuit in the photoelectric conversion device according to the first embodiment.

FIG. 4 is a circuit diagram illustrating a configuration example of an AD conversion circuit in the photoelectric conversion device according to the first embodiment.

FIG. 5A and FIG. 5B are schematic diagrams illustrating a configuration example of the photoelectric conversion device according to the first embodiment.

FIG. 6 is a timing chart illustrating the operation of the photoelectric conversion device according to the first embodiment.

FIG. 7 is a schematic cross-sectional view illustrating the structure of a capacitor.

FIG. 8, FIG. 9, FIG. 10, and FIG. 11 are circuit diagrams illustrating another configuration example of the column circuit in the photoelectric conversion device according to the first embodiment.

FIG. 12 is a circuit diagram illustrating a configuration example of a level shift circuit in a photoelectric conversion device according to a second embodiment.

FIG. 13 is a circuit diagram illustrating a configuration example of a level shift circuit in a photoelectric conversion device according to a third embodiment.

FIG. 14 is a circuit diagram illustrating a configuration example of a level shift circuit in a photoelectric conversion device according to a fourth embodiment.

FIG. 15 is a circuit diagram illustrating a configuration example of a current source and a level shift circuit in a photoelectric conversion device according to a fifth embodiment.

FIG. 16 is a circuit diagram illustrating a configuration example of a level shift circuit in a photoelectric conversion device according to a sixth embodiment.

FIG. 17 is a circuit diagram illustrating another configuration example of the current source and the level shift circuit in the photoelectric conversion device according to the sixth embodiment.

FIG. 18 is a block diagram illustrating a schematic configuration of a photoelectric conversion system according to a seventh embodiment.

FIG. 19A is a diagram illustrating a configuration example of a photoelectric conversion system according to an eighth embodiment.

FIG. 19B is a diagram illustrating a configuration example of a movable object according to the eighth embodiment.

FIG. 20 is a block diagram illustrating a schematic configuration of an equipment according to a ninth embodiment.

### DESCRIPTION OF THE EMBODIMENTS

Preferred embodiments of the present disclosure will now be described in detail in accordance with the accompanying drawings. In each of the embodiments described below, as an example of the photoelectric conversion device, a device used for imaging will be mainly described. However, each embodiment is not limited to a device for the imaging application and may be applied to other examples included as a photoelectric conversion device. For example, there are a distance measuring device (device for distance measurement using focus detection or time-of-flight (TOF), and the like), a photometric device (device for measuring the amount of incident light, etc.), and the like.

The conductivity type of each of the transistors described in the embodiments described below is merely an example and is not limited to the conductivity type described in the embodiments. The conductivity type may be appropriately changed with respect to the conductivity type described in the embodiments, and the potentials of the gate, the source, and the drain of the transistor may be appropriately changed in accordance with the change. For example, in the case of a transistor operating as a switch, low-level and high-level of the potential supplied to the gate may be reversed with respect to the description in the embodiment as the conductivity type is changed. Note that in this specification, a source and a drain of each node of a transistor may be referred to as a main node, and a gate thereof may be referred to as a control node.

In the following embodiments, connection between elements of a circuit may be described. In this case, even when another element is interposed between the elements of interest, the elements of interest are treated as being connected to each other unless otherwise specified. For example, it is assumed that an element A is connected to one node of a capacitor C having a plurality of nodes, and an element B is connected to the other node. Even in such a case, the element A and the element B are regarded as being connected to each other unless otherwise specified.

### First Embodiment

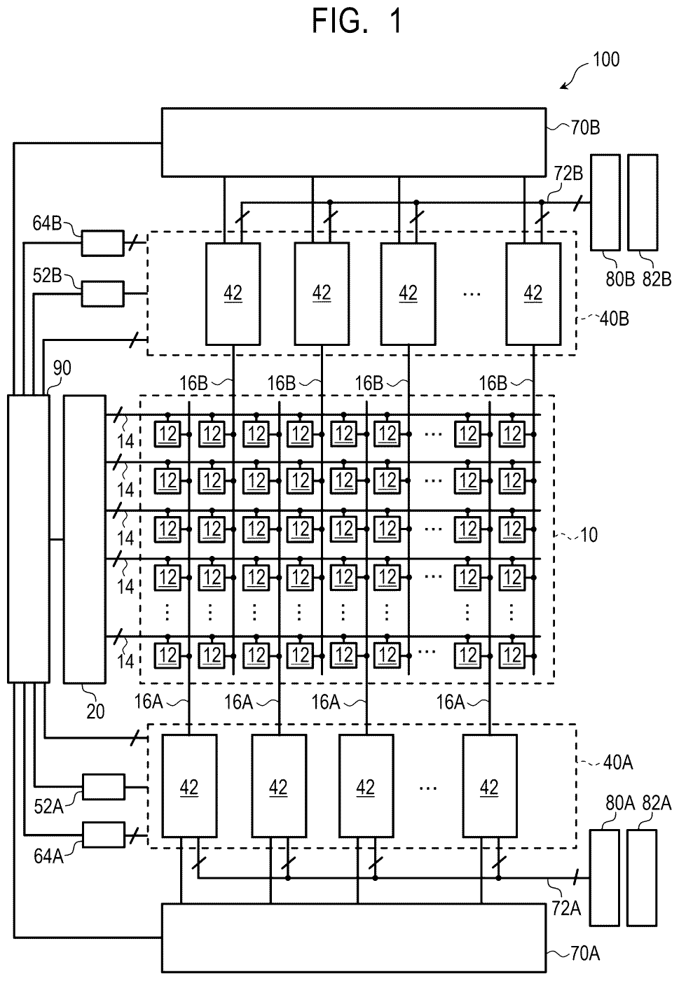

A photoelectric conversion device and a method of driving the same according to a first embodiment of the present disclosure will be described with reference to FIG. 1 to FIG. 6.

FIG. 1 is a block diagram illustrating the schematic configuration of a photoelectric conversion device according to the present embodiment. As illustrated in FIG. 1, the photoelectric conversion device 100 according to the present embodiment includes a pixel array unit 10, a vertical scanning circuit 20, readout circuits 40A and 40B, reference signal output circuits 52A and 52B, and counter circuits 64A and 64B. The photoelectric conversion device 100 further includes horizontal scanning circuits 70A and 70B, processing circuits 80A and 80B, output circuits 82A and 82B, and a control circuit 90.

The pixel array unit 10 is provided with a plurality of pixels 12 arranged in a matrix over a plurality of rows and a plurality of columns. Each pixel 12 includes a photoelectric conversion unit including a photoelectric conversion element such as a photodiode, and outputs a pixel signal according to the amount of incident light. The number of rows and the number of columns of the pixel array arranged in the pixel array unit 10 are not particularly limited. In addition to effective pixels that output pixel signals according to the amount of incident light, the pixel array unit 10 may include optical black pixels in which photoelectric conversion units are shielded from light, dummy pixels that do not output signals, and the like. A specific configuration of the pixel 12 will be described later.

In each row of the pixel array unit 10, a control line 14 is arranged so as to extend in a first direction (lateral direction in FIG. 1). Each of the control lines 14 is connected to the pixels 12 arranged in the first direction on the corresponding row and forms a signal line common to these pixels 12. Each of the control lines 14 may include a plurality of signal lines. The first direction in which the control lines 14 extend may be referred to as a row direction or a horizontal direction. The control lines 14 are connected to the vertical scanning circuit 20.

In each column of the pixel array unit 10, a signal output line 16A or a signal output line 16B is arranged so as to extend in a second direction (vertical direction in FIG. 1) intersecting the first direction. The signal output lines 16A and 16B are alternately arranged in each column. For example, the signal output lines 16A are arranged in odd-numbered columns, and the signal output lines 16B are arranged in even-numbered columns. Each of the signal output lines 16A and 16B is connected to the pixels 12 arranged in the second direction on the corresponding column and forms a signal line common to these pixels 12. The signal output lines 16A are connected to the readout circuit 40A. The signal output lines 16B are connected to the readout circuit 40B. The signal output lines 16A and 16B may include a plurality of signal lines.

The vertical scanning circuit 20 has a function of generating a control signal for driving the pixels 12 in response to a control signal from the control circuit 90 and outputting the generated control signal to the pixel array unit 10. A logic circuit such as a shift register or an address decoder may be used as the vertical scanning circuit 20. The vertical scanning circuit 20 sequentially outputs control signals to the control lines 14 of each row and performs an operation of sequentially driving the pixels 12 of the pixel array unit 10 in units of rows, that is, a so-called vertical scanning. The signals read out from the pixels 12 in units of rows are input to the readout circuit 40A or the readout circuit 40B via the signal output line 16A or the signal output line 16B arranged in each column of the pixel array unit 10.

The readout circuit 40A includes a plurality of column circuits 42 corresponding to the number of columns in which the signal output lines 16A are arranged. Each of the column circuits 42 of the readout circuit 40A is connected to the signal output line 16A of the corresponding column. Similarly, the readout circuit 40B includes a plurality of column circuits 42 corresponding to the number of columns in which the signal output lines 16B are arranged. Each of the column circuits 42 of the readout circuit 40B is connected to the signal output line 16B of the corresponding column. The column circuit 42 is a signal processing circuit that performs predetermined processing on the pixel signals read out from the pixels 12 in the corresponding column. Examples of the processing performed by the column circuit 42 may include signal processing such as amplification processing and analog-to-digital conversion (AD conversion) processing. The column circuit 42 includes a signal holding circuit (memory) for holding the processed pixel signal.

The reference signal output circuit 52A is connected to the readout circuit 40A. The reference signal output circuit 52A has a function of outputting a reference signal used for the AD conversion to the readout circuit 40A in response to a control signal from the control circuit 90. Similarly, the reference signal output circuit 52B is connected to the readout circuit 40B. The reference signal output circuit 52B has a function of outputting a reference signal used for the AD conversion to the readout circuit 40B in response to a control signal from the control circuit 90. The reference signal output circuits 52A and 52B may be configured to generate the reference signal and output the generated reference signal or may be configured to buffer and output the reference signal generated outside the photoelectric conversion device.

The reference signal used for the AD conversion may have a predetermined amplitude according to the range of the pixel signal and may be a signal whose signal level changes with time. Although the reference signal is not particularly limited, for example, a ramp signal in which the signal level monotonically increases or monotonically decreases with time may be applied. Note that the change in the signal level does not necessarily have to be continuous and may be stepwise. In addition, the change in the signal level does not necessarily need to be linear with respect to time and may be curvilinearly changed with respect to time (for example, a sine wave or a cosine wave).

The counter circuit 64A is connected to the readout circuit 40A. The counter circuit 64A has a function of performing a count operation in accordance with a control signal from the control circuit 90 and outputting a count signal indicating the count value to the readout circuit 40A. The counter circuit 64A starts the count operation in synchronization with a timing at which a change in the signal level of the reference signal supplied from the reference signal output circuit 52A starts. Similarly, the counter circuit 64B is connected to the readout circuit 40B. The counter circuit 64B has a function of performing a count operation in accordance with a control signal from the control circuit 90 and outputting a count signal indicating the count value to the readout circuit 40B. The counter circuit 64B starts the count operation in synchronization with a timing at which a change in the signal level of the reference signal supplied from the reference signal output circuit 52B starts. Each of the column circuits 42 may have the function of the counter circuit 64A or 64B.

Although an example in which a slope type AD conversion circuit is used for the AD conversion of the pixel signal is mainly described in the present embodiment, the AD conversion circuit is not limited to the slope type AD conversion circuit. In addition to the slope type AD conversion circuit, for example, a successive approximation register (SAR) type AD conversion circuit, a delta-sigma type AD conversion circuit, a pipeline type AD conversion circuit, or the like may be applied to the AD conversion of the pixel signal. In these cases, the reference signal output circuits 52A and 52B and the counter circuits 64A and 64B are not necessary.

The horizontal scanning circuit 70A has a function of generating a control signal for reading out the pixel signal from the column circuit 42 of the readout circuit 40A in response to a control signal from the control circuit 90 and outputting the generated control signal to the readout circuit 40A. The horizontal scanning circuit 70A performs an operation of sequentially scanning, that is a so-called horizontal scanning, the column circuits 42 of the readout circuit 40A and sequentially outputting the pixel signals held therein to the processing circuit 80A via the horizontal output line 72A. Similarly, the horizontal scanning circuit 70B has a function of generating a control signal for reading out the pixel signal from the column circuit 42 of the readout circuit 40B in response to a control signal from the control circuit 90 and outputting the generated control signal to the readout circuit 40B. The horizontal scanning circuit 70B performs the same horizontal scanning as that of the horizontal scanning circuit 70A on the column circuit 42 of the readout circuit 40B. A logic circuit such as a shift register or an address decoder may be used for the horizontal scanning circuits 70A and 70B.

The processing circuit 80A may include a buffer amplifier, a differential amplifier, and the like, and has a function of performing predetermined signal processing on the pixel signal of the column selected by the horizontal scanning circuit 70A and outputting the processed pixel data to the output circuit 82A. Similarly, the processing circuit 80B may include a buffer amplifier, a differential amplifier, and the like, and has a function of performing predetermined signal processing on the pixel signal of the column selected by the horizontal scanning circuit 70B and outputting the processed pixel data to the output circuit 82B. Examples of the signal processing performed by the processing circuits 80A and 80B may include correction processing by correlated double sampling (CDS), amplification processing, and the like.

The output circuit 82A includes an external interface circuit and has a function of outputting the image data input from the processing circuit 80A to the outside of the photoelectric conversion device 100. Similarly, the output circuit 82B includes an external interface circuit and has a function of outputting image data input from the processing circuit 80B to the outside of the photoelectric conversion device 100. The external interface circuits included in the output circuits 82A and 82B are not particularly limited. As the external interface circuit, for example, a SERializer/DESerializer (SerDes) transmission circuit such as a Low Voltage Differential Signaling (LVDS) circuit or a Scalable Low Voltage Signaling (SLVS) circuit may be applied.

The control circuit 90 has a function of generating control signals for controlling the operations of the above-described functional blocks and outputting the generated control signals to these functional blocks. At least a part of the control signals for controlling the operations of these functional blocks may be supplied from the outside of the photoelectric conversion device 100.

FIG. 1 illustrates an example in which two readout circuit blocks including a readout circuit block including the readout circuit 40A, the horizontal scanning circuit 70A, the processing circuit 80A, and the like, and a readout circuit block including the readout circuit 40B, the horizontal scanning circuit 70B, the processing circuit 80B, and the like are provided. However, the number of readout circuit blocks is not necessarily two and may be one.

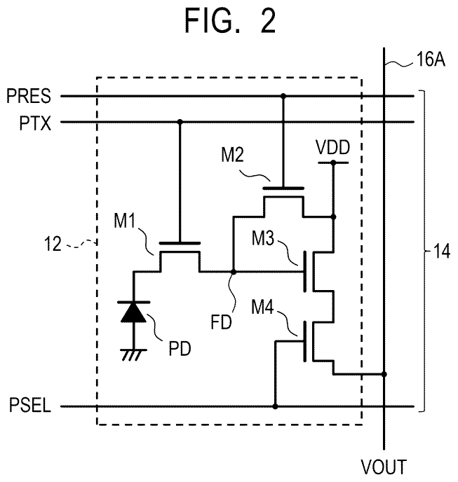

FIG. 2 is a circuit diagram illustrating a configuration example of the pixel in the photoelectric conversion device according to the present embodiment. Each of the pixels 12 included in the pixel array unit 10 may include, for example, as illustrated in FIG. 2, a photoelectric conversion element PD, a transfer transistor M1, a reset transistor M2, an amplifier transistor M3, and a select transistor M4.

The photoelectric conversion element PD is, for example, a photodiode, and has an anode connected to a ground voltage line and a cathode connected to a source of the transfer transistor M1. A drain of the transfer transistor M1 is connected to a source of the reset transistor M2 and a gate of the amplifier transistor M3. The node FD to which the drain of the transfer transistor M1, the source of the reset transistor M2, and the gate of the amplifier transistor M3 are connected is a so-called floating diffusion. The floating diffusion includes a capacitance component (floating diffusion capacitance) and has a function as a charge holding portion. The floating diffusion capacitance may include a gate capacitance, a p-n junction capacitance, an interconnection capacitance, and the like of the transistor. A drain of the reset transistor M2 and a drain of the amplifier transistor M3 are connected to a node to which the power supply voltage (for example, the voltage VDD) is supplied. A source of the amplifier transistor M3 is connected to a drain of the select transistor M4. A source of the select transistor M4 is connected to the signal output line 16A (or the signal output line 16B).

In the case of the pixel configuration of FIG. 2, the control line 14 of each row includes three signal lines including a signal line connected to a gate of the transfer transistor M1, a signal line connected to a gate of the reset transistor M2, and a signal line connected to a gate of the select transistor M4. The control signal PTX is supplied from the vertical scanning circuit 20 to the gate of the transfer transistor M1. The control signal PRES is supplied from the vertical scanning circuit 20 to the gate of the reset transistor M2. The control signal PSEL is supplied from the vertical scanning circuit 20 to the gate of the select transistor M4. In the case where each transistor is formed of an n-channel transistor, when a high-level control signal is supplied from the vertical scanning circuit 20, the corresponding transistor is turned on. When a low-level control signal is supplied from the vertical scanning circuit 20, the corresponding transistor is turned off.

The present embodiment will be described on the assumption that electrons among electron-hole pairs generated in the photoelectric conversion element PD by light incidence are used as the signal charge. When electrons are used as the signal charge, each transistor constituting the pixel 12 may be formed of an n-channel transistor. However, the signal charge is not limited to electrons, and holes may be used as the signal charge. When holes are used as the signal charge, the conductivity type of each transistor may be opposite to that described in the present embodiment. The names of the source and the drain of the MOS transistor may vary depending on the conductivity type of the transistor and the function of interest. Some or all of the names of the source and the drain used in the present embodiment may be referred to as reverse names. In this specification, one of the source and the drain may be referred to as a first main node, the other of the source and the drain may be referred to as a second main node, and the gate may be referred to as a control node.

The photoelectric conversion element PD converts (photoelectrically converts) the incident light into charge of an amount corresponding to the amount of the incident light and accumulates the generated charge. The transfer transistor M1 transfers the charge held by the photoelectric conversion element PD to the node FD by turning on. The charge transferred from the photoelectric conversion element PD is held in the capacitance (floating diffusion capacitance) of the node FD. As a result, the node FD becomes a potential corresponding to the amount of charge transferred from the photoelectric conversion element PD by charge-voltage conversion by the floating diffusion capacitance.

The select transistor M4 connects the amplifier transistor M3 to the signal output line 16A (or the signal output line 16B) by turning on. The amplifier transistor M3 has the drain to which the voltage VDD is supplied and the source to which a bias current is supplied from a current source (a current source 44 described later) (not illustrated) via the select transistor M4. Accordingly, the amplifier transistor M3 constitutes an amplifier unit (source follower circuit) having the gate as an input node, and outputs a signal based on the potential of the node FD to the signal output line 16A (or the signal output line 16B) via the select transistor M4. In this sense, the amplifier transistor M3 and the select transistor M4 form an output unit that outputs the pixel signal according to the amount of charge held in the node FD.

The reset transistor M2 has a function of controlling supply of a voltage (voltage VDD) for resetting the node FD as a charge holding portion to the FD node. The reset transistor M2 resets the node FD to a voltage corresponding to the voltage VDD by turning on.

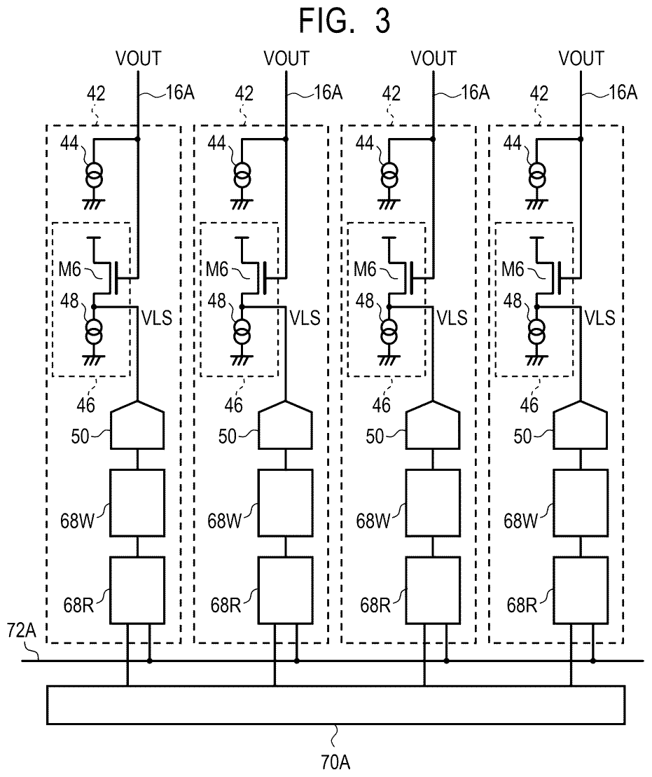

FIG. 3 is a circuit diagram illustrating a configuration example of a column circuit in the photoelectric conversion device according to the present embodiment. FIG. 3 illustrates four of the plurality of column circuits 42 constituting the readout circuit 40A. The signal output line 16A of each column is connected to the column circuit 42 of the corresponding column. As illustrated in, e.g., FIG. 3, each of the column circuits 42 may include a current source 44, a level shift circuit 46, an AD conversion circuit 50, and memories 68W and 68R. As described above, the current source 44 functions as a load current source of the amplifier transistor M3 of the pixel 12. The level shift circuit 46 includes a transistor M6 and a current source 48.

One node of the current source 44 is connected to the signal output line 16A. The other node of the current source 44 is connected to the ground voltage node. A drain of the transistor M6 is connected to a node to which the power supply voltage (for example, the voltage VDD) is supplied. A source of the transistor M6 is connected to one node of the current source 48 and an input node of the AD conversion circuit 50. The other node of the current source 48 is connected to the ground voltage node. A gate of the transistor M6 is connected to the signal output line 16A. The transistor M6 has a configuration in which the voltage VDD is supplied to the drain and the bias current is supplied to the source from the current source 48 and constitutes a source follower circuit having the gate as an input node and the connection node between the transistor M6 and the current source 48 as an output node. The gate of the transistor M6 is an input node of the level shift circuit 46, and the connection node between the source of the transistor M6 and one node of the current source 48 is an output node of the level shift circuit 46.

Note that the level shift circuit is a circuit that outputs a signal whose waveform is the same as that of an input signal and whose voltage level is different from that of the input signal. The level shift circuit 46 according to the present embodiment outputs an input signal after shifting the level of the input signal in a direction in which the voltage becomes smaller. Here, the direction in which the voltage becomes smaller is a direction in which the potential difference with respect to a voltage serving as a reference of the power supply voltage (here, referred to as a reference voltage) becomes smaller. The reference voltage is generally a ground voltage but is not necessarily limited to the ground voltage. When the pixel circuit is formed of the n-channel transistors as described above, the level shift circuit 46 shifts the level of the signal of the signal output line 16A in a direction in which the signal level decreases and outputs the signal.

An output node of the AD conversion circuit 50 is connected to an input node of the memory 68W. The memory 68R has two input nodes and one output node. One input node of the memory 68R is connected to an output node of the memory 68W. The other input node of the memory 68R is connected to the horizontal scanning circuit 70A. An output node of the memory 68R is connected to the horizontal output line 72A.

The signal VOUT of the signal output line 16A is input to the level shift circuit 46. The level shift circuit 46 performs a level-shift on the signal VOUT to a lower voltage and outputs the processed signal to the AD conversion circuit 50. The output of the level shift circuit 46 is a signal VLS. The level shift amount in the level shift circuit 46 is the gate-source voltage of the transistor M6.

The AD conversion circuit 50 performs the AD conversion on the signal VLS, which is an analog signal, and outputs to the memory 68W. The memory 68W holds the signal output from the AD conversion circuit 50 as digital data of the pixel signal. The memory 68R holds digital data of the pixel signal transferred from the memory 68W. The digital data held in the memory 68R is sequentially transferred to the processing circuit 80A via the horizontal output line 72A for each column in accordance with the control signal supplied from the horizontal scanning circuit 70A. By providing the memory 68R in the subsequent stage of the memory 68W, the AD conversion operation in the AD conversion circuit 50 may be performed in parallel with the transfer operation to the processing circuit 80A. The digital data transferred to the processing circuit 80A is subjected to predetermined signal processing in the processing circuit 80A and then output to the outside of the chip via the output circuit 82A.

The column circuit 42 of the readout circuit 40B is the same as the column circuit 42 of the readout circuit 40A except that the column circuit 42 of the readout circuit 40A is arranged in a column different from the column in which the column circuit 42 is arranged, and thus description thereof is omitted. Hereinafter, the column circuit 42 of the readout circuit 40A will be described, but the same applies to the column circuit 42 of the readout circuit 40B. In addition, in the following description, when the signal output lines 16A and 16B, the readout circuits 40A and 40B, and the like are commonly described, “A” and “B” may not be distinguished from each other and may be referred to as the signal output line 16, the readout circuit 40, and the like. In addition, in the case where a plurality of similar constituent elements is provided, a serial number such as 1, 2, 3, . . . is given to each reference numeral, and these may be distinguished from each other.

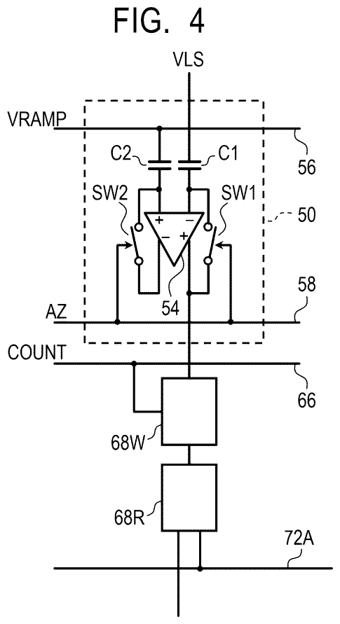

FIG. 4 is a circuit diagram illustrating a configuration example of the AD conversion circuit 50 when a slope type AD conversion circuit is applied as the AD conversion circuit 50. The slope type AD conversion circuit 50 may include, as illustrated in, e.g., FIG. 1 and FIG. 4, a reference signal output circuit 52A, a counter circuit 64A, a comparison circuit 54, capacitors C1 and C2, and switches SW1 and SW2.

The comparison circuit 54 may be comprised of, for example, a differential amplifier circuit, and may include a non-inverting input node (+), an inverting input node (−), a non-inverting output node (+), and an inverting output node (−). The inverting input node of the comparison circuit 54 is connected to the output line of the level shift circuit 46 via the capacitor C1. The signal VLS is input to the inverting input node of the comparison circuit 54 from the level shift circuit 46 via the capacitor C1. The non-inverting input node of the comparison circuit 54 is connected to the reference signal line 56 via the capacitor C2. The reference signal VRAMP output from the reference signal output circuit 52A is input to the non-inverting input node of the comparison circuit 54 via the reference signal line 56 and the capacitor C2. A switch SW1 is connected between the inverting input node and the non-inverting output node of the comparison circuit 54. A switch SW2 is connected between the non-inverting input node and the inverting output node of the comparison circuit 54. The switches SW1 and SW2 are controlled by a control signal AZ supplied from the control circuit 90 via the AZ signal line 58. The switches SW1 and SW2 are reset switches for resetting the threshold voltage of the comparison circuit 54.

The memories 68W and 68R have two input nodes and one output node. One input node of the memory 68W is connected to a non-inverting output node of the comparison circuit 54. The other input node of the memory 68W is connected to the count signal line 66. The count signal COUNT is supplied from the counter circuit 64A to the other input node of the memory 68W via the count signal line 66. One input node of the memory 68R is connected to an output node of the memory 68W. The other input node of the memory 68R is connected to the horizontal scanning circuit 70A. An output node of the memory 68R is connected to the horizontal output line 72A.

The comparison circuit 54 compares the level of the signal VLS supplied from the level shift circuit 46 via the capacitor C1 with the level of the reference signal VRAMP supplied from the reference signal line 56 via the capacitor C2, and outputs a signal according to the comparison result. For example, the comparison circuit 54 outputs a high-level signal when the level of the reference signal VRAMP is lower than the level of the signal VLS. When the level of the reference signal VRAMP is higher than the level of the signal VLS, the comparison circuit 54 outputs a low-level signal. The relationship between the magnitude of the input signal and the level of the output signal may be reversed.

The memory 68W holds the count value indicated by the count signal COUNT supplied from the counter circuit 64A at the timing when the level of the non-inverting output node of the comparison circuit 54 is inverted, as digital data of the pixel signal. The memory 68R holds digital data of the pixel signal transferred from the memory 68W. The digital data held in the memory 68R is sequentially transferred to the processing circuit 80A via the horizontal output line 72A for each column in accordance with the control signal supplied from the horizontal scanning circuit 68A.

Instead of providing the counter circuit 64A, the memory 68W of the column circuit 42 may have a function of a counter circuit. In this case, the memory 68W of the column circuit 42 of each column receives the common clock signal output from the control circuit 90 and counts the pulses of the clock signal. The count value at the timing when the level of the output signal of the comparison circuit 54 is inverted is digital data held in the memory 68W.

The photoelectric conversion device 100 according to the present embodiment may have a configuration in which all the functional blocks described above are disposed on one substrate or may have a configuration in which functional blocks are separately formed on each substrate as a stacked type in which a plurality of substrates are stacked.

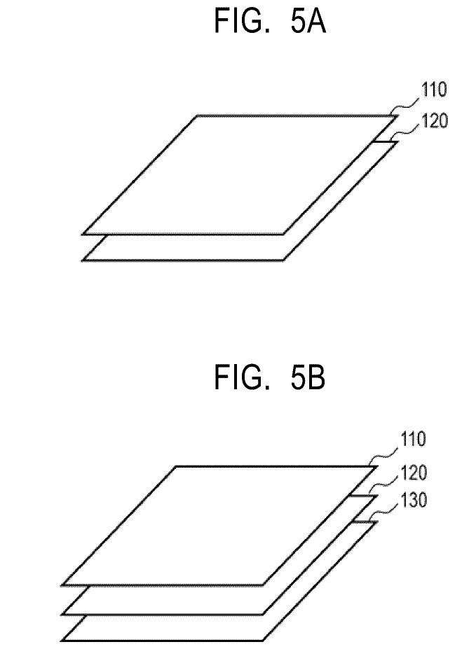

FIG. 5A and FIG. 5B are schematic diagrams illustrating a configuration example of the photoelectric conversion device according to the present embodiment. FIG. 5A is a schematic view of a case where the pixel substrate 110 on which the pixel array unit 10 is disposed and the circuit substrate 120 on which other functional blocks are disposed are stacked. By arranging the pixel array unit 10 and the other functional blocks on different substrates, it is possible to reduce the size of the photoelectric conversion device 100 without sacrificing the area of the pixel array unit 10. FIG. 5B is a schematic view of a case where the pixel substrate 110 on which the pixel array unit 10 is disposed and circuit substrates 120 and 130 on which other functional blocks are disposed are stacked. Also in this case, it is possible to reduce the size of the photoelectric conversion device 100 without sacrificing the area of the pixel array unit 10.

The circuit elements constituting one functional block are not necessarily arranged on the same substrate and may be arranged on different substrates.

Next, the operation of the photoelectric conversion device 100 according to the present embodiment will be described with reference to FIG. 6. FIG. 6 is a timing chart illustrating the operation of the photoelectric conversion device according to the present embodiment. The timing chart of FIG. 6 illustrates waveforms of the control signals PTX, PRES, and AZ, the reference signal VRAMP, and the signal VLS of the output line of the level shift circuit 46. Here, it is assumed that a corresponding transistor or switch is turned on when the control signals PTX, PRES, and AZ are at high-level, and a corresponding transistor or switch is turned off when the control signals PTX, PRES, and AZ are at low-level.

Just before time t0, the control signal PSEL (not illustrated) of the row to be read out is at high-level. As a result, the select transistor M4 of each of the pixels 12 belonging to the row to be read out is turned on, and each of the pixels 12 is in a state capable of outputting the pixel signal to the signal output line 16A of the corresponding column. Just before the time to, the control signals PTX and PRES of the row to be read out and the control signal AZ are at low-level, and the reference signal VRAMP is at a predetermined initial voltage.

In a period from the time t0 to time t1, the vertical scanning circuit 20 controls the control signal PRES of the row to be read out to high-level. As a result, the reset transistor M2 of each of the pixels 12 belonging to the row to be read out is turned on, and the node FD is reset to a voltage corresponding to the voltage VDD.

A signal VOUT having a voltage corresponding to the reset voltage of the node FD (a pixel signal of a reset level) is output to the signal output line 16A. The signal VLS of the output line of the level shift circuit 46 also becomes a predetermined reset level according to the signal VOUT. At the time t1, the control signal PRES transitions to low-level and the reset transistor M2 is turned off, whereby the reset state of the node FD is cancelled.

In a period from the time to to time t2, the control circuit 90 controls the control signal AZ to high-level. As a result, the switches SW1 and SW2 of the column circuit 42 of each column are turned on, and the inverting input node and the non-inverting input node of the comparison circuit 54 are reset to the voltage of the reset level. That is, at the time t2, one node of the capacitor C1 is at the voltage of the reset level of the signal VLS, and the other node of the capacitor C1 is at the voltage of the reset level of the comparison circuit 54. One node of the capacitor C2 is at the initial voltage of the reference signal VRAMP, and the other node of the capacitor C2 is at the voltage of the reset level of the comparison circuit 54. The threshold voltage of the comparison circuit 54 is reset to a voltage corresponding to the potential difference between the voltage of the reset level of the signal VLS and the initial voltage of the reference signal VRAMP.

The threshold voltage of the comparison circuit 54 is a voltage corresponding to a difference between the signal level of the signal VLS and the signal level of the reference signal VRAMP when the level of the comparison signal output from the comparison circuit 54 changes. That is, the comparison circuit 54 outputs a comparison signal indicating a different level between the case where the difference between the signal level of the signal VLS and the signal level of the reference signal VRAMP is smaller than the threshold voltage and the case where the difference is larger than the threshold voltage.

At the subsequent time t2, the control circuit 90 controls the control signal AZ to low-level. Accordingly, the switches SW1 and SW2 of the column circuit 42 of each column are turned off, the reset level of the signal VLS is clamped by the capacitor C1, and the reference level corresponding to the initial voltage of the reference signal VRAMP is clamped by the capacitor C2.

At the subsequent time t4, the reference signal output circuit 52A increases the reference signal VRAMP from the initial voltage to a predetermined start voltage. Then, the reference signal output circuit 52A starts a slope operation in which the voltage of the reference signal VRAMP changes with time from the subsequent time t5. The counter circuit 64A starts counting up simultaneously with the start of the slope operation, and outputs a count signal COUNT indicating the count value to the column circuit 42 of each column via the count signal line 66.

The comparison circuit 54 compares the level of the signal VLS input via the capacitor C1 with the level of the reference signal VRAMP input via the capacitor C2. Then, the comparison circuit 54 inverts the level of the output signal at a timing when the magnitude relationship between the level of the signal VLS and the level of the reference signal VRAMP changes, for example, at time t6 in FIG. 6.

The memory 68W holds the count value indicated by the count signal COUNT output from the counter circuit 64A at the timing when the level of the output signal of the comparison circuit 54 is inverted as digital data of the pixel signal of the reset level of the pixel 12. In this way, AD conversion is performed on the pixel signal of the reset level of the pixel 12. The digital data held in the memory 68W is transferred to the memory 68R and then transferred to the processing circuit 80A in accordance with the control signal from the horizontal scanning circuit 70A.

At the subsequent time t7, the reference signal output circuit 52A resets the reference signal VRAMP to the level of the initial voltage.

In the subsequent period from time t8 to time t9, the vertical scanning circuit 20 controls the control signal PTX of the row to be read out to high-level. Accordingly, the transfer transistor M1 of each of the pixels 12 belonging to the row to be read out is turned on, and the charge accumulated in the photoelectric conversion element PD during a predetermined exposure period is transferred to the node FD. As a result, the voltage of the node FD decreases according to the amount of charge transferred from the photoelectric conversion element PD, and the level of the signal VOUT of the signal output line 16A and the level of the signal VLS of the output line of the level shift circuit 46 also decreases. A signal VOUT having a voltage corresponding to the voltage of the node FD (a pixel signal of a light signal level) is output to the signal output line 16A. The signal VLS of the output line of the level shift circuit 46 also becomes a predetermined level corresponding to the signal VOUT.

At the subsequent time t10, the reference signal output circuit 52A increases the reference signal VRAMP from the initial voltage to a predetermined start voltage. Then, the reference signal output circuit 52A starts a slope operation in which the voltage of the reference signal VRAMP changes with time from the subsequent time t11. The counter circuit 64A starts counting up simultaneously with the start of the slope operation, and outputs a count signal COUNT indicating the count value to the column circuit 42 of each column via the count signal line 66.

The comparison circuit 54 compares the level of the signal VLS input via the capacitor C1 with the level of the reference signal VRAMP input via the capacitor C2. Then, the comparison circuit 54 inverts the level of the output signal at a timing when the magnitude relationship between the level of the signal VLS and the level of the reference signal VRAMP changes, for example, at time t12 in FIG. 6.

The memory 68W holds the count value indicated by the count signal COUNT supplied from the counter circuit 64A at the timing when the level of the output signal of the comparison circuit 54 is inverted as digital data of the pixel signal. In this way, AD conversion is performed on the pixel signal of the light signal level. The digital data held in the memory 68W is transferred to the memory 68R and then transferred to the processing circuit 80A in accordance with the control signal from the horizontal scanning circuit 70A.

The digital data of the pixel signal thus acquired is subjected to correction processing by CDS in the processing circuit 80A in the subsequent stage. In the correction processing by the CDS, the digital data of the pixel signal of the reset level is subtracted from the digital data of the pixel signal of the light signal level, and the noise component superimposed on the pixel signal of the light signal level is removed.

As described above, in the present embodiment, the level shift circuit 46 performs the level-shift on the signal VOUT of the signal output line 16A to a lower voltage and outputs the level-shifted signal VLS to the AD conversion circuit 50. With this configuration, for example, the chip area may be reduced. Hereinafter, this point will be described.

Here, in the pixel circuit of FIG. 2, it is assumed that the power supply voltage (voltage VDD) is 3 V and the reset level of the node FD is 3 V. At this time, if the gate-source voltage of the amplifier transistor M3 is 0.5 V, the reset level of the signal output line 16A becomes 2.5 V. In addition, it is assumed that the voltage of the signal output line 16A decreases to 1.5 V in accordance with a decrease in the voltage of the node FD when the signal charge corresponding to the maximum amount of charge that can be held in the photoelectric conversion element PD is transferred to the node FD. In this case, a possible voltage range of the signal output line 16A is 1.5 V to 2.5 V.

When the level shift amount in the level shift circuit 46 is 1.25 V and the gain is 1, the possible voltage range of the output of the level shift circuit 46 (signal VLS) is 0.25 V to 1.25 V. That is, the maximum value of the voltage output to the AD conversion circuit 50 is reduced by half from 2.5 V to 1.25 V by the level shift circuit 46. Thus, the size of the capacitor C1 may be reduced, and the chip area may be reduced. Hereinafter, this point will be described in more detail.

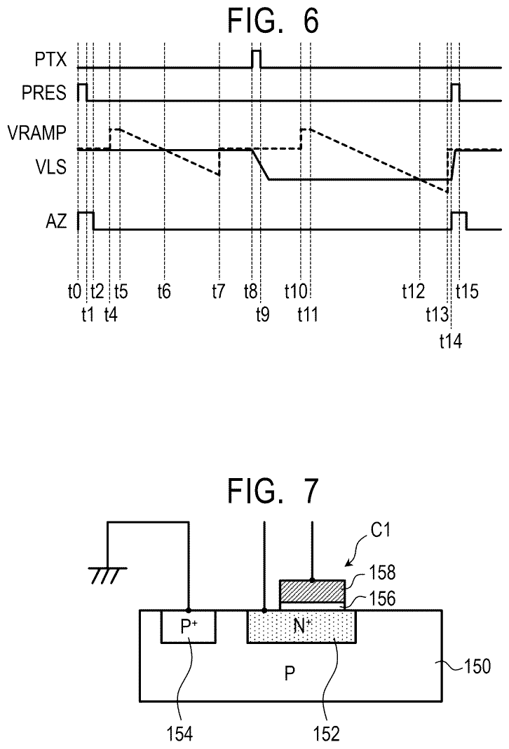

FIG. 7 illustrates an example of a cross-sectional structure of the capacitor C1. An n⁺ diffused layer 152 and a p⁺ diffused layer 154 are provided in the p-well 150. A polycrystalline silicon electrode 158 is provided over the n⁺ diffused layer 152 with an insulating film 156 interposed therebetween. Thus, a capacitor C1 is formed in which the polycrystalline silicon electrode 158 serves as one electrode, the n⁺ diffused layer 152 serves as the other electrode, and the insulating film 156 serves as a capacitor dielectric film. For example, one electrode formed of the polycrystalline silicon electrode 158 may be connected to the level shift circuit 46, and the other electrode formed of the n⁺ diffused layer 152 may be connected to the comparison circuit 54. The p-well 150 is connected to the ground voltage node via the p⁺ diffused layer 154.

The capacitance value Cₒₓ per unit area of the capacitor is expressed as Cₒₓ=εₒₓ/tₒₓ, where εₒₓ (=ε₀×εᵣ) is the dielectric constant of the insulating film 156, and tₒₓ is the thickness thereof. When silicon oxide having a thickness of 10 nm is assumed as the insulating film 156, the capacitance value Cₒₓ is 8.854×10⁻¹²×3.9/(10×10⁻⁹)=3.45×10⁻³ [F/m²]. In the circuit configuration of FIG. 4, the capacitors C1 and C2 often have relatively large capacitance values for the purpose of reducing kTC noise when the switches SW1 and SW2 are off. For example, assuming that 345 fF is necessary as the capacitance value Cₒₓ of the capacitors C1 and C2, the electrode areas of the capacitors C1 and C2 are 100 μm².

When the maximum voltage input from the level shift circuit 46 to the polycrystalline silicon electrode 158 is halved from 2.5 V to 1.25 V as described above, the thickness tₒₓ of the insulating film 156 may be reduced. For example, when the thickness of the insulating film 156 is halved from 10 nm to 5 nm, the capacitance value per unit area is doubled, so that the electrode area may be reduced from 100 μm² to 50 μm² while maintaining the same capacitance value.

Since it is desirable that the capacitors C1 and C2 connected to the pair of differential input nodes of the comparison circuit 54 have the same configuration in consideration of differentiality, it is possible to realize a further reduction in area by also thinning the insulating film of the capacitor C2. Since the size of the transistor M6 and the transistor constituting the current source 48 may be realized in an area of, for example, about 1 μm², even if the level shift circuit 46 is added, the total area may be sufficiently reduced.

It is also possible to lower the voltage level of the input signal of the AD conversion circuit 50 by lowering the power supply voltage of the pixel circuit from 3 V to, for example, 1.75 V and lowering the possible voltage range of the signal output line 16A from 0.25 V to 1.25 V. However, if the possible voltage range of the signal output line 16A is shifted too low, the leakage current of the select transistor M4 of the pixels 12 in the non-readout row connected to the signal output line 16A increases, and there is a possibility that image quality degradation such as linearity degradation may occur.

In this regard, in the present embodiment, instead of lowering the voltage level of the signal output line 16A, the level shift circuit 46 performs the level-shift on the signal of the signal output line 16A to a lower voltage and outputs the processed signal to the AD conversion circuit 50. Therefore, according to the present embodiment, it is possible to reduce the chip area while suppressing image quality degradation.

The reduction in chip area due to the reduction in size of the capacitors C1 and C2 is one example of an effect obtained by providing the level shift circuit 46. By providing the level shift circuit 46, various effects according to the configuration of the column circuit 42 may be realized.

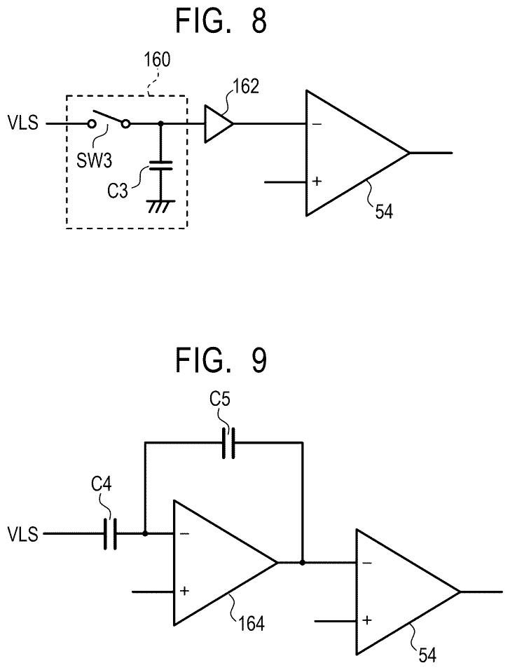

For example, as illustrated in FIG. 8, the column circuit 42 may further include a sample-and-hold circuit 160 including a capacitor C3 and a switch SW3 and a buffer circuit 162 between the level shift circuit 46 and the comparison circuit 54. That is, one node of the switch SW3 is connected to the output line of the level shift circuit 46. The other node of the switch SW3 is connected to one node of the capacitor C3 and an input node of the buffer circuit 162. The other node of the capacitor C3 is connected to the ground voltage node. The output node of the buffer circuit 162 is connected to the inverting input node of the comparison circuit 54. In the case of such a column circuit 42, the possible voltage range of the signal VLS is narrowed, so that the size of the capacitor C3 used for sampling and holding the signal may be reduced. Thus, the chip area may be reduced as in the case of the capacitor C1.

Alternatively, for example, as illustrated in FIG. 9, the column circuit 42 may further include a gain amplifier including an amplifier 164 and capacitors C4 and C5 between the level shift circuit 46 and the comparison circuit 54. That is, one node of the capacitor C4 is connected to the output line of the level shift circuit 46. The other node of the capacitor C4 is connected to the inverting input node of the amplifier 164 and one node of the capacitor C5. An output node of the amplifier 164 is connected to the other node of the capacitor C5 and an inverting input node of the comparison circuit 54. By connecting the gain amplifier between the level shift circuit 46 and the comparison circuit 54, a gain determined by the ratio of the capacitance value of the capacitor C4 and the capacitance value of the capacitor C5 may be applied to the signal VLS and then input to the comparison circuit 54. Also in this case, the size of the capacitors C4 and C5 may be reduced by narrowing the voltage range that the signal VLS can take. Thus, the chip area may be reduced as in the case of the capacitor C1. Note that a gain amplifier having a variable gain may be configured by using a variable capacitance value of at least one of the capacitors C4 and C5.

Alternatively, as illustrated in, e.g., FIG. 10, the column circuit 42 may be configured to connect the output line of the level shift circuit 46 to the inverting input node of the comparison circuit 54 without using the capacitor C1. When the maximum voltage of the signal VLS output from the level shift circuit 46 drops from, for example, 2.5 V to 1.25 V, the power supply voltage of the comparison circuit 54 may also be reduced from, for example, 2.5 V to 1.25 V. In order to improve the accuracy of the AD conversion, the slew rate when the output of the comparison circuit 54 is inverted is required to be high, and the current flowing through the AD conversion circuit 50 is, for example, about 10 μA. In this case, the power of 12.5 μW may be reduced by reducing the power supply voltage of the comparison circuit 54 from 2.5 V to 1.25 V. Therefore, when the power supply voltage of the level shift circuit 46 is 2.5 V and the current of the current source 48 is 5 μA or less, power consumption may be reduced. That is, by providing the level shift circuit 46, it is possible to reduce the power supply voltage supplied to the comparison circuit and reduce the power. In this specification, the magnitude of the power supply voltage means a potential difference between the power supply voltage and a voltage (reference voltage) serving as a reference of the power supply voltage. When the reference voltage is the ground voltage, the magnitude of the power supply voltage is the same as the absolute value of the power supply voltage.

In the above description, a slope type AD conversion circuit is assumed as the AD conversion circuit 50, but the AD conversion circuit 50 is not limited to the slope type AD conversion circuit. For example, even when a SAR type AD conversion circuit using a capacitive DAC as an input unit is applied, it is possible to obtain an effect of reducing the chip size by reducing the capacitor size.

Further, the AD conversion circuit 50 may be a delta-sigma type AD conversion circuit. In the delta-sigma type AD conversion circuit, for example, as illustrated in FIG. 11, an integrator including a switched capacitor circuit 166, an amplifier 168, and a capacitor C7 is connected to the level shift circuit 46. The switched capacitor circuit 166 may include a capacitor C6 and switches SW4, SW5, SW6, and SW7. That is, one node of the switch SW4 is connected to the output line of the level shift circuit 46. The other node of the switch SW4 is connected to one node of the capacitor C6 and one node of the switch SW5. The other node of the capacitor C6 is connected to one node of the switch SW6 and one node of the switch SW7. The other node of the switch SW7 is connected to the inverting input node of the amplifier 168 and one node of the capacitor C7. An output node of the amplifier 168 is connected to the other node of the capacitor C7. In the case of such a column circuit 42, it is possible not only to reduce the chip size by reducing the size of the capacitor C6, but also to reduce the image quality degradation by suppressing the current fluctuation of the pixel 12.

In the circuit of FIG. 11, the non-inverting input node of the amplifier 168 is grounded, and the inverting input node also has a potential near 0 V. Since the switched capacitor circuit 166 contributes like a resistor, a current that changes according to the output signal of the level shift circuit 46 flows into the capacitor C7 via the inverting input node of the amplifier 168, and an integration operation is performed. In the case where the level shift circuit 46 is not provided, the current flowing through the pixel 12 changes according to the pixel signal, which may cause deterioration in image quality. In this regard, in the present embodiment, since the input current that changes according to the pixel signal is supplied from the level shift circuit 46, it is possible to suppress the current fluctuation in the pixel 12.

As described above, in the AD conversion circuit 50 having the current input type configuration such as the delta-sigma type AD conversion circuit illustrated in FIG. 11, it is possible to suppress the degradation of the image quality by suppressing the current fluctuation in the pixel in addition to the chip size reduction.

Further, when the AD conversion circuit 50 is an oversampling type AD conversion circuit such as a delta-sigma type AD conversion circuit, random noise generated in the level shift circuit 46 due to oversampling may be suppressed. This may reduce the disadvantage of adding the level shift circuit 46.

As described above, according to the present embodiment, since the level shift circuit that outputs the pixel signal after shifting the level of the pixel signal in the direction of decreasing the voltage is provided in the input unit of the column circuit, it is possible to realize the reduction in area and the reduction in power consumption of the photoelectric conversion device.

### Second Embodiment

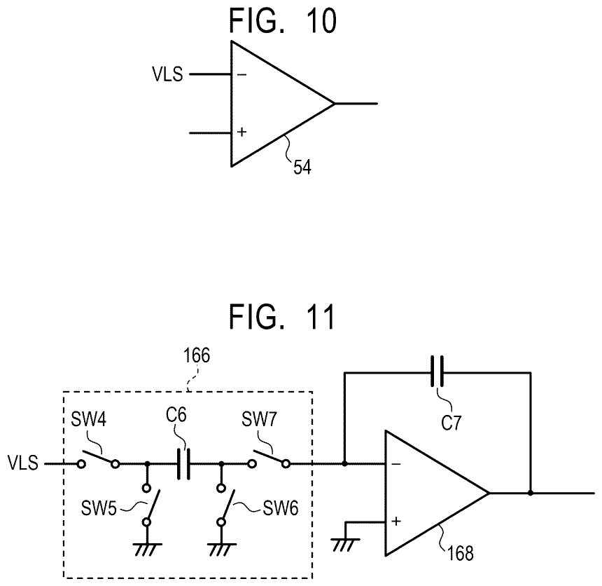

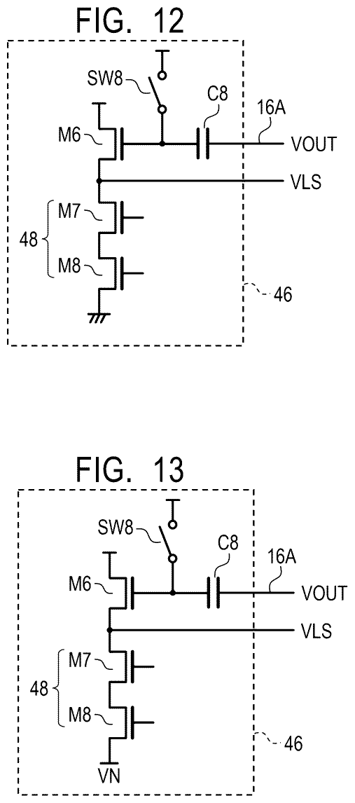

A photoelectric conversion device and a method of driving the same according to a second embodiment of the present disclosure will be described with reference to FIG. 12. The same components as those of the photoelectric conversion device according to the first embodiment are denoted by the same reference numerals, and description thereof will be omitted or simplified. FIG. 12 is a circuit diagram illustrating a configuration example of a level shift circuit 46 in the photoelectric conversion device according to the present embodiment.

The photoelectric conversion device according to the present embodiment is the same as the photoelectric conversion device according to the first embodiment except that the configuration of the level shift circuit 46 is different. In the present embodiment, differences from the photoelectric conversion device according to the first embodiment will be mainly described, and description of points similar to those of the photoelectric conversion device according to the first embodiment will be appropriately omitted.

In the level shift circuit 46 of the photoelectric conversion device according to the present embodiment, as illustrated in FIG. 12, the current source 48 includes a current source transistor M8 and a cascode transistor M7 connected to the current source transistor M8 in a cascode connection. The level shift circuit 46 further includes a capacitor C8 and a switch SW8. The gate of the transistor M6 is connected to one node of the switch SW8 and one node of the capacitor C8. The other node of the switch SW8 is connected to a node to which a predetermined voltage is supplied. The other node of the capacitor C8 is connected to the signal output line 16A. The source of the transistor M6 is connected to a drain of the cascode transistor M7. A source of the cascode transistor M7 is connected to a drain of the current source transistor M8. A source of the current source transistor M8 is connected to the ground voltage node. A connection node between the source of the transistor M6 and the drain of the cascode transistor M7 is an output node of the level shift circuit 46 from which the signal VLS is output. A predetermined bias voltage is applied to a gate of the cascode transistor M7 and a gate of the current source transistor M8.

The capacitor C8 and the switch SW8 constitute a clamp circuit. After the noise signal output from the pixel 12 is clamped by the capacitor C8, the photoelectric conversion signal is output from the pixel 12, whereby the threshold voltage variation of the amplifier transistor M3 for each pixel 12 may be removed. This makes it possible to reduce variations in the output voltage of the level shift circuit 46. Further, by controlling the voltage supplied via the switch SW8, the range of the voltage of the signal output to the AD conversion circuit 50 may be controlled.

In addition, when the threshold voltage of the transistor M6 is fluctuated in a direction in which the threshold voltage is large and the voltage of the output signal is changed so as to be low, by controlling the voltage supplied via the switch SW8 so as to be high, it is possible to further reduce the variation in the output voltage. That is, by making the voltage supplied via the switch SW8 variable, it is possible to further reduce variations in the output voltage. The voltage supplied via the switch SW8 may be changed in conjunction with the threshold voltage of the transistor M6.

As described above, according to the present embodiment, since the level shift circuit that outputs the pixel signal after shifting the level of the pixel signal in the direction of decreasing the voltage is provided in the input unit of the column circuit, it is possible to realize the reduction in area and the reduction in power consumption of the photoelectric conversion device.

### Third Embodiment

A photoelectric conversion device and a method of driving the same according to a third embodiment of the present disclosure will be described with reference to FIG. 13. The same components as those of the photoelectric conversion device according to the first or second embodiment are denoted by the same reference numerals, and description thereof will be omitted or simplified. FIG. 13 is a circuit diagram illustrating a configuration example of a level shift circuit 46 in the photoelectric conversion device according to the present embodiment.

The photoelectric conversion device according to the present embodiment is the same as the photoelectric conversion device according to the first or second embodiment except that the configuration of the level shift circuit 46 is different. In the present embodiment, differences from the photoelectric conversion device according to the second embodiment will be mainly described, and description of points similar to those of the photoelectric conversion device according to the second embodiment will be appropriately omitted.

As illustrated in FIG. 13, the level shift circuit 46 of the photoelectric conversion device according to the present embodiment is the same as the level shift circuit 46 of the photoelectric conversion device according to the second embodiment except that the source of the current source transistor M8 is connected to the node to which the voltage VN is supplied. That is, the current source transistor M8 of the level shift circuit 46 of the second embodiment is connected to the ground voltage node, whereas the current source transistor M8 of the level shift circuit 46 of the present embodiment is connected to the node to which the voltage VN is supplied. The voltage VN has a polarity opposite to that of the voltage VDD, and is, for example, −0.5 V.

By configuring the level shift circuit 46 in this manner, the operation of the current source 48 may be maintained even when the voltage range of the signal VLS output to the AD conversion circuit 50 is shifted to the low voltage side by controlling the voltage supplied via the switch SW8. For example, even when the voltage supplied via the switch SW8 is adjusted so that the voltage range of the signal VLS output to the AD conversion circuit 50 is 0 V to 1 V, a voltage difference of 0.5 V may be secured between the drain of the cascode transistor M7 and the source of the current source transistor M8. This makes it possible to reduce the maximum voltage of the signal VLS output to the AD conversion circuit 50 and further reduce the chip area while ensuring the operation of the cascode transistor M7 and the current source transistor M8 in the saturation region.

As described above, according to the present embodiment, since the level shift circuit that outputs the pixel signal after shifting the level of the pixel signal in the direction of decreasing the voltage is provided in the input unit of the column circuit, it is possible to realize the reduction in area and the reduction in power consumption of the photoelectric conversion device.

### Fourth Embodiment

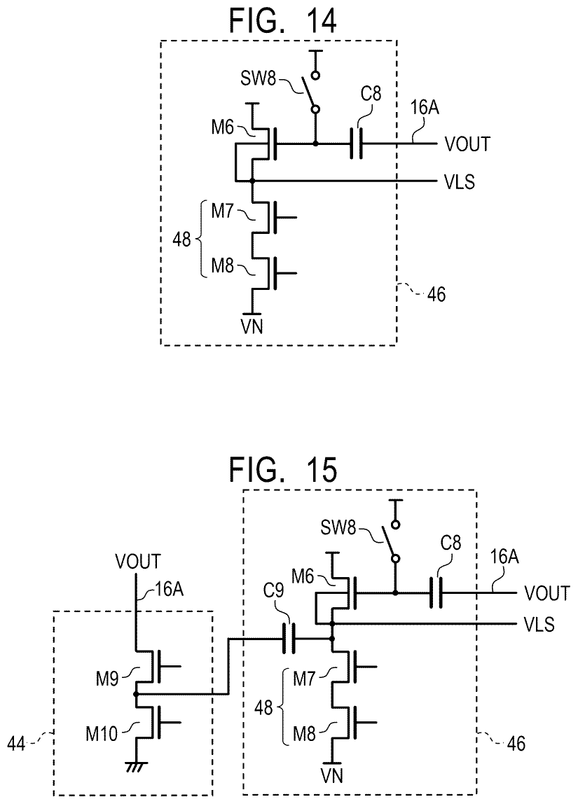

A photoelectric conversion device and a method of driving the same according to a fourth embodiment of the present disclosure will be described with reference to FIG. 14. The same components as those of the photoelectric conversion devices according to the first to third embodiments are denoted by the same reference numerals, and description thereof will be omitted or simplified. FIG. 14 is a circuit diagram illustrating a configuration example of a level shift circuit 46 in the photoelectric conversion device according to the present embodiment.

The photoelectric conversion device according to the present embodiment is the same as the photoelectric conversion devices according to the first to third embodiments except that the configuration of the level shift circuit 46 is different. In the present embodiment, differences from the photoelectric conversion device according to the third embodiment will be mainly described, and description of points similar to those of the photoelectric conversion device according to the third embodiment will be appropriately omitted.

As illustrated in FIG. 14, the level shift circuit 46 of the photoelectric conversion device according to the present embodiment is the same as the level shift circuit 46 of the photoelectric conversion device according to the second embodiment except that the source and a back gate of the transistor M6 are connected to each other. By configuring the level shift circuit 46 in this way, it is possible to improve the linearity of the source follower circuit constituted by the transistor M6 and the current source transistor M8, and to suppress image quality degradation.

As described above, according to the present embodiment, since the level shift circuit that outputs the pixel signal after shifting the level of the pixel signal in the direction of decreasing the voltage is provided in the input unit of the column circuit, it is possible to realize the reduction in area and the reduction in power consumption of the photoelectric conversion device.

### Fifth Embodiment

A photoelectric conversion device and a method of driving the same according to a fifth embodiment of the present disclosure will be described with reference to FIG. 15. The same components as those of the photoelectric conversion devices according to the first to fourth embodiments are denoted by the same reference numerals, and description thereof will be omitted or simplified. FIG. 15 is a circuit diagram illustrating a configuration example of a level shift circuit 46 in the photoelectric conversion device according to the present embodiment.

The photoelectric conversion device according to the present embodiment is the same as the photoelectric conversion devices according to the first to fourth embodiments except that the configurations of the current source 44 and the level shift circuit 46 are different. In the present embodiment, differences from the photoelectric conversion device according to the fourth embodiment will be mainly described, and description of points similar to those of the photoelectric conversion device according to the fourth embodiment will be appropriately omitted.

As illustrated in FIG. 15, the current source 44 of the photoelectric conversion device according to the present embodiment includes a current source transistor M10 and a cascode transistor M9. The level shift circuit 46 of the photoelectric conversion device according to the present embodiment further includes a capacitor C9 in addition to the configuration of the fourth embodiment. A drain of the cascode transistor M9 is connected to the signal output line 16A. A source of the cascode transistor M9 is connected to a drain of the current source transistor M10. A source of the current source transistor M10 is connected to the ground voltage node. A connection node between the source of the cascode transistor M9 and the drain of the current source transistor M10 is connected to the output node of the level shift circuit 46 via the capacitor C9. A predetermined bias voltage is applied to a gate of the current source transistor M10 and a gate of the cascode transistor M9. The current source 44 is not limited to the illustrated configuration. For example, the current source 44 does not necessarily include the cascode transistor M9 and may include one current source transistor M10.

According to the above configuration of the present embodiment, since the output of the source follower connected to the signal output line 16A is connected to the drain of the current source transistor M10, the signal response speed in the signal output line 16A may be increased. In other words, the signal response speed in the signal output line 16A may be increased by using the level shift circuit 46 for reducing the area of the AD conversion circuit 50.

As described above, according to the present embodiment, since the level shift circuit that outputs the pixel signal after shifting the level of the pixel signal in the direction of decreasing the voltage is provided in the input unit of the column circuit, it is possible to realize the reduction in area and the reduction in power consumption of the photoelectric conversion device.

### Sixth Embodiment

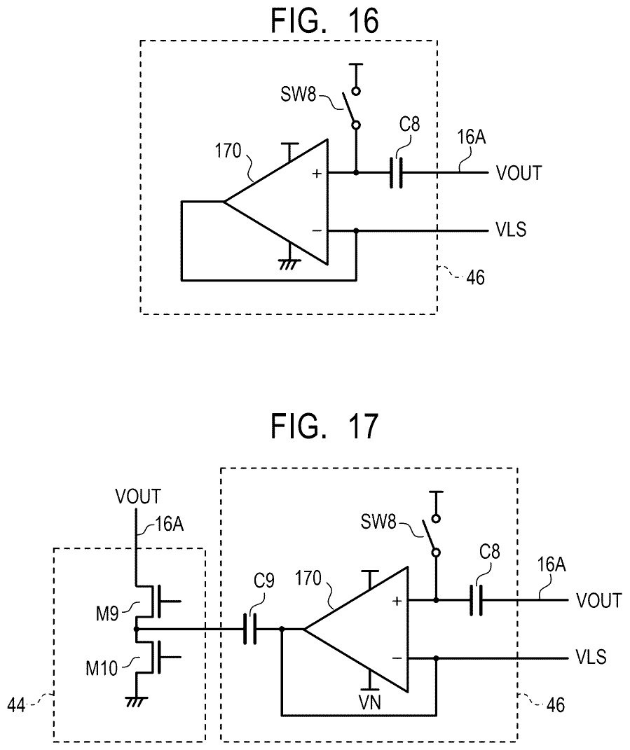

A photoelectric conversion device and a method of driving the same according to a sixth embodiment of the present disclosure will be described with reference to FIG. 16 and FIG. 17. The same components as those of the photoelectric conversion devices according to the first to fifth embodiments are denoted by the same reference numerals, and description thereof will be omitted or simplified. FIG. 16 is a circuit diagram illustrating a configuration example of a level shift circuit 46 in the photoelectric conversion device according to the present embodiment. FIG. 17 is a circuit diagram illustrating a configuration example of a level shift circuit 46 in the photoelectric conversion device according to the modification of the present embodiment.

The photoelectric conversion device according to the present embodiment is similar to the photoelectric conversion devices according to the first to fifth embodiments except that the configuration of the level shift circuit 46 is different. In the present embodiment, differences from the photoelectric conversion devices according to the second to fourth embodiments will be mainly described, and description of points similar to those of the photoelectric conversion devices according to the second to fourth embodiments will be appropriately omitted.

Unlike the second to fourth embodiments, the level shift circuit 46 of the photoelectric conversion device according to the present embodiment is configured by using an operational amplifier 170 instead of a source follower configured by the transistor M6, the cascode transistor M7, and the current source transistor M8. That is, as illustrated in FIG. 16, the level shift circuit 46 of the present embodiment may include an operational amplifier 170, a capacitor C8, and a switch SW8.

One node of the switch SW8 and one node of the capacitor C8 are connected to a non-inverting input node of the operational amplifier 170. The other node of the switch SW8 is connected to a node to which a predetermined voltage is supplied. The other node of the capacitor C8 is connected to the signal output line 16A. An inverting input node of the operational amplifier 170 is connected to an output node of the operational amplifier 170. The inverting input node of the operational amplifier 170 is also an output node of the level shift circuit 46 from which the signal VLS is output.

By configuring the level shift circuit 46 as described above and controlling the voltage supplied via the switch SW8 to a predetermined voltage lower than the reset level of the signal output line 16A, the voltage of the signal VLS output to the AD conversion circuit 50 may be level-shifted in a low direction. In the fourth embodiment, the threshold voltage variation of the transistor M6 affects the signal VLS output to the AD conversion circuit 50, but in the present embodiment, the variation of the signal VLS may be reduced by using the operational amplifier 170.

Further, by using the operational amplifier 170, it is possible to suppress image quality degradation in the case where the AD conversion circuit 50 is of a current input type as illustrated in FIG. 11. That is, in the case where the level shift circuit 46 is of the type using the source follower as in the second to fourth embodiments, when the output voltage changes and the output current to the AD conversion circuit 50 changes, the current flowing through the transistor M6 changes. This change in current causes the power supply voltage connected to the drain of the transistor M6 to fluctuate and also affects the power supply voltage supplied to the level shift circuit 46 of the column circuit 42 of another column. As a result, the image quality may deteriorate. In this regard, when the operational amplifier 170 is used as in the present embodiment, the influence of interference between columns via the power supply may be reduced by improving the power supply rejection ratio (PSRR), and image quality degradation may be suppressed.

The additional configurations described in the third to fifth embodiments are also applicable to the present embodiment. For example, in the present embodiment, the power supply node on the low voltage side of the operational amplifier 170 is connected to the ground voltage node, but as illustrated in FIG. 16, the power supply node on the low voltage side of the operational amplifier 170 may be connected to a node to which the negative voltage VN is supplied. The current source 44 may include the cascode transistor M9 and the current source transistor M10, and the connection node between the cascode transistor M9 and the current source transistor M10 may be connected to the output node of the level shift circuit 46 via the capacitor C9.

As described above, according to the present embodiment, since the level shift circuit that outputs the pixel signal after shifting the level of the pixel signal in the direction of decreasing the voltage is provided in the input unit of the column circuit, it is possible to realize the reduction in area and the reduction in power consumption of the photoelectric conversion device.

### Seventh Embodiment

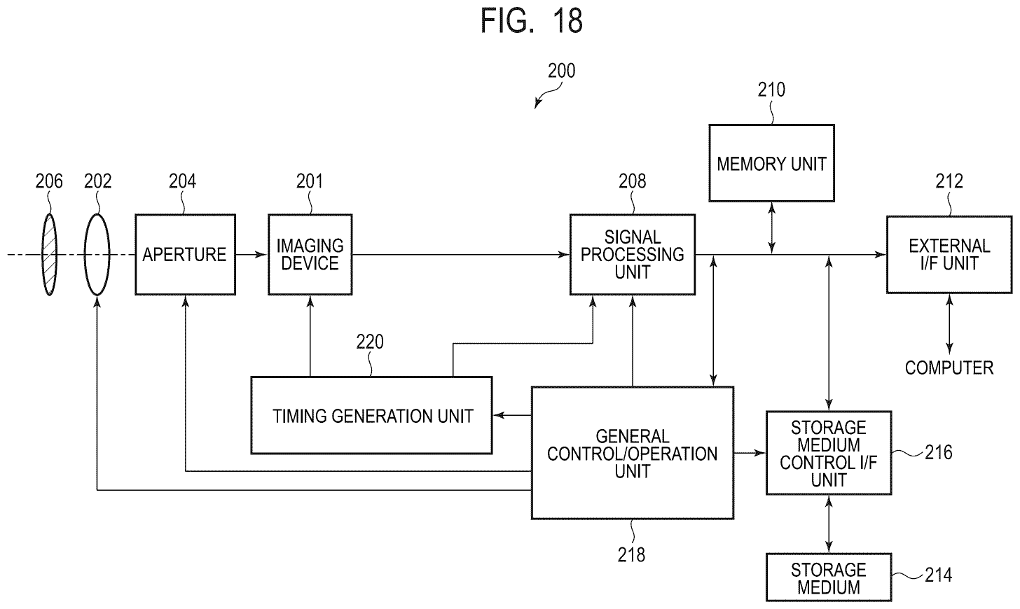

A photoelectric conversion system according to a seventh embodiment of the present disclosure will be described with reference to FIG. 18. FIG. 18 is a block diagram illustrating a schematic configuration of a photoelectric conversion system according to the present embodiment.

The photoelectric conversion device 100 described in the first to sixth embodiments may be applied to various photoelectric conversion systems. Examples of applicable photoelectric conversion systems include digital still cameras, digital camcorders, surveillance cameras, copying machines, facsimiles, mobile phones, on-vehicle cameras, observation satellites, and the like. A camera module including an optical system such as a lens and an imaging device is also included in the photoelectric conversion system. FIG. 18 exemplifies a block diagram of a digital still camera as one of these.

The photoelectric conversion system 200 illustrated in FIG. 18 includes an imaging device 201, a lens 202 that forms an optical image of an object on the imaging device 201, an aperture 204 that changes the amount of light passing through the lens 202, and a barrier 206 that protects the lens 202. The lens 202 and the aperture 204 form an optical system that focuses light onto the imaging device 201. The imaging device 201 is the photoelectric conversion device 100 described in any of the first to sixth embodiments and converts the optical image formed by the lens 202 into image data.

The photoelectric conversion system 200 further includes a signal processing unit 208 that processes an output signal output from the imaging device 201. The signal processing unit 208 generates image data from the digital signal output from the imaging device 201. Further, the signal processing unit 208 performs various corrections and compressions as necessary and outputs the processed image data. The imaging device 201 may include an AD conversion unit that generates a digital signal to be processed by the signal processing unit 208. The AD conversion unit may be formed on a semiconductor layer (semiconductor substrate) on which the photoelectric conversion unit of the imaging device 201 is formed or may be formed on a semiconductor layer different from the semiconductor layer on which the photoelectric conversion unit of the imaging device 201 is formed. In addition, the signal processing unit 208 may be formed on the same semiconductor layer as the imaging device 201.

The photoelectric conversion system 200 further includes a memory unit 210 for temporarily storing image data and an external interface unit (external I/F unit) 212 for communicating with an external computer or the like. The photoelectric conversion system 200 further includes a storage medium 214 such as a semiconductor memory for performing storing or reading out of imaging data, and a storage medium control interface unit (storage medium control I/F unit) 216 for performing storing on or reading out from the storage medium 214. The storage medium 214 may be built in the photoelectric conversion system 200 or may be detachable.

The photoelectric conversion system 200 further includes an general control/operation unit 218 that performs various calculations and controls the entire digital still camera, and a timing generation unit 220 that outputs various timing signals to the imaging device 201 and the signal processing unit 208. Here, the timing signal or the like may be input from the outside, and the photoelectric conversion system 200 may include at least the imaging device 201 and the signal processing unit 208 that processes the output signal output from the imaging device 201.

The imaging device 201 outputs an imaging signal to the signal processing unit 208. The signal processing unit 208 performs predetermined signal processing on the imaging signal output from the imaging device 201, and outputs the processed image data. The signal processing unit 208 generates an image using the imaging signal.

As described above, according to the present embodiment, it is possible to realize a photoelectric conversion system to which the photoelectric conversion device 100 according to any of the first to sixth embodiments is applied.

### Eighth Embodiment

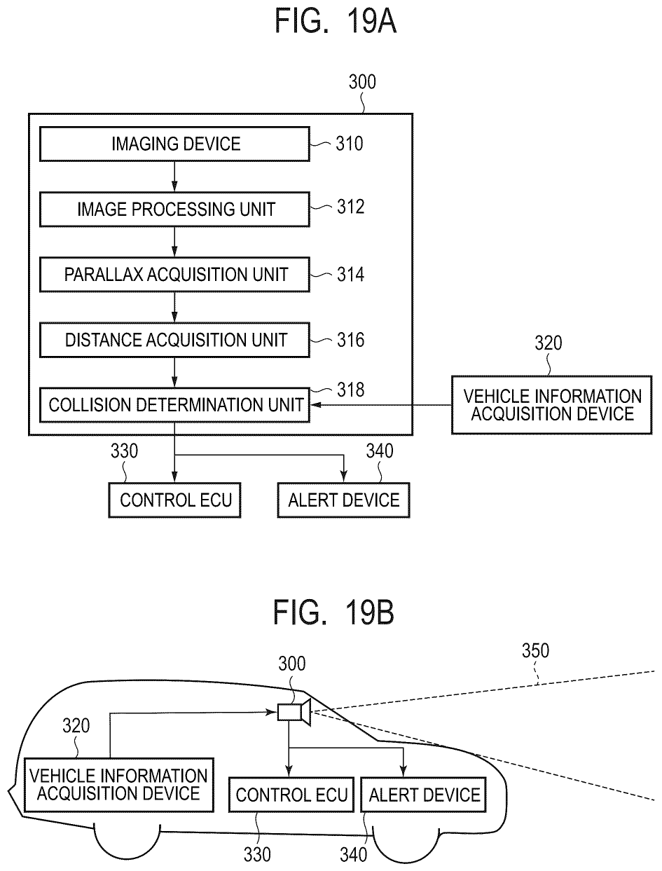

A photoelectric conversion system and a movable object according to an eighth embodiment of the present disclosure will be described with reference to FIG. 19A and FIG. 19B. FIG. 19A is a diagram illustrating a configuration of a photoelectric conversion system according to the present embodiment. FIG. 19B is a diagram illustrating a configuration of a movable object according to the present embodiment.

FIG. 19A illustrates an example of a photoelectric conversion system related to an on-vehicle camera. The photoelectric conversion system 300 includes an imaging device 310. The imaging device 310 is the photoelectric conversion device 100 according to any one of the first to sixth embodiments. The photoelectric conversion system 300 includes an image processing unit 312 that performs image processing on a plurality of image data acquired by the imaging device 310, and a parallax acquisition unit 314 that calculates parallax (phase difference of parallax images) from the plurality of image data acquired by the imaging device 310. The photoelectric conversion system 300 further includes a distance acquisition unit 316 that calculates a distance to an object based on the calculated parallax, and a collision determination unit 318 that determines whether there is a collision possibility based on the calculated distance. Here, the parallax acquisition unit 314 and the distance acquisition unit 316 are examples of a distance information acquisition unit that acquires distance information to the object. That is, the distance information is information related to a parallax, a defocus amount, a distance to the object, and the like. The collision determination unit 318 may determine the collision possibility using any of the distance information. The distance information acquisition unit may be realized by dedicatedly designed hardware or may be realized by a software module. Further, it may be realized by a field programmable gate array (FPGA), application specific integrated circuit (ASIC), or the like, or may be realized by a combination of these.

The photoelectric conversion system 300 is connected to the vehicle information acquisition device 320 and may acquire vehicle information such as a vehicle speed, a yaw rate, and a steering angle. Further, the photoelectric conversion system 300 is connected to a control ECU 330 which is a control device that outputs a control signal for generating a braking force to the vehicle based on the determination result of the collision determination unit 318. The photoelectric conversion system 300 is also connected to an alert device 340 that issues an alert to the driver based on the determination result of the collision determination unit 318. For example, when the determination result of the collision determination unit 318 indicates that the possibility of collision is high, the control ECU 330 performs vehicle control to avoid collision and reduce damage by, for example, applying a brake, returning an accelerator, or suppressing engine output. The alert device 340 gives an alert to the user by sounding an alarm such as a sound, displaying alert information on a screen of a car navigation system or the like, giving vibration to a seat belt or a steering wheel, or the like.

In the present embodiment, an image of the surroundings of the vehicle, for example, the front or the rear is captured by the photoelectric conversion system 300. FIG. 19B illustrates the photoelectric conversion system in the case of capturing an image in front of the vehicle (imaging range 350). The vehicle information acquisition device 320 sends instructions to the photoelectric conversion system 300 or the imaging device 310. With such a configuration, the accuracy of distance measurement may be further improved.

Although an example in which control is performed so as not to collide with another vehicle has been described above, the present disclosure is also applicable to control in which automatic driving is performed so as to follow another vehicle, control in which automatic driving is performed so as not to protrude from a lane, and the like. Further, the photoelectric conversion system is not limited to a vehicle such as an own vehicle, and may be applied to, for example, other movable objects (mobile devices), such as, for example, a ship, an aircraft, or an industrial robot. In addition, the present disclosure is not limited to the movable object and may be widely applied to equipment using object recognition, such as intelligent transport systems (ITS).

### Ninth Embodiment

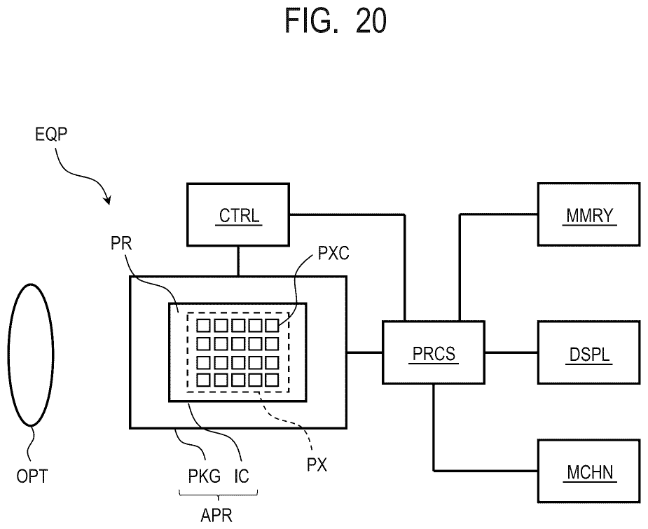

An equipment according to a ninth embodiment of the present disclosure will be described with reference to FIG. 20. FIG. 20 is a block diagram illustrating a schematic configuration of an equipment according to the present embodiment.

FIG. 20 is a schematic diagram illustrating an equipment EQP including a photoelectric conversion device APR. The photoelectric conversion device APR has the function of the photoelectric conversion device 100 according to any of the first to sixth embodiments. All or part of the photoelectric conversion device APR is a semiconductor device IC. The photoelectric conversion device APR of the present example may be used as, for example, an image sensor, an auto focus (AF) sensor, a photometric sensor, or a distance measurement sensor. The semiconductor device IC includes a pixel region PX in which pixel circuits PXC each including a photoelectric conversion unit are arranged in a matrix. The semiconductor device IC may include a peripheral region PR around the pixel region PX. A circuit other than the pixel circuit may be disposed in the peripheral region PR.

The photoelectric conversion device APR may have a structure (chip stacked structure) in which a first semiconductor chip provided with a plurality of photoelectric conversion units and a second semiconductor chip provided with peripheral circuits are stacked. Each of the peripheral circuits in the second semiconductor chip may be column circuits corresponding to pixel columns of the first semiconductor chip. The peripheral circuits in the second semiconductor chip may be matrix circuits corresponding to pixels or pixel blocks in the first semiconductor chip. As the connection between the first semiconductor chip and the second semiconductor chip, a through electrode (through silicon via (TSV)), an inter-chip interconnection by direct bonding of a conductor such as copper, a connection by a micro bump between chips, a connection by wire bonding, or the like may be employed.

The photoelectric conversion device APR may include a package PKG that accommodates the semiconductor device IC in addition to the semiconductor device IC. The package PKG may include a base body to which the semiconductor device IC is fixed, a lid body such as glass facing the semiconductor device IC, and connection members such as bonding wires or bumps for connecting terminals provided on the base body and terminals provided on the semiconductor device IC.

The equipment EQP may further include at least one of an optical device OPT, a control device CTRL, a processing device PRCS, a display device DSPL, a storage device MMRY, and a mechanical device MCHN. The optical device OPT corresponds to the photoelectric conversion device APR as a photoelectric conversion device, and is, for example, a lens, a shutter, or a mirror. The control device CTRL controls the photoelectric conversion device APR, and is, for example, a semiconductor device such as an ASIC. The processing device PRCS processes a signal output from the photoelectric conversion device APR and constitutes an analog front end (AFE) or a digital front end (DFE). The processing unit PRCS is a semiconductor device such as a central processing unit (CPU) or an ASIC. The display device DSPL may be an electroluminescent (EL) display device or a liquid crystal display (LCD) device that displays information (image) obtained by the photoelectric conversion device APR. The storage device MMRY may be a magnetic device or a semiconductor device that stores information (image) obtained by the photoelectric conversion device APR. The storage device MMRY may be a volatile memory such as an SRAM or a DRAM, or a nonvolatile memory such as a flash memory or a hard disk drive. The mechanical device MCHN may include a movable portion or a propulsion portion such as a motor or an engine. In the equipment EQP, a signal output from the photoelectric conversion device APR is displayed on the display device DSPL or transmitted to the outside by a communication device (not illustrated) included in the equipment EQP. Therefore, it is preferable that the equipment EQP further includes a storage device MMRY and a processing device PRCS separately from the storage circuit unit and the arithmetic circuit unit included in the photoelectric conversion device APR.

The equipment EQP illustrated in FIG. 20 may be an electronic device such as an information terminal (for example, a smartphone or a wearable terminal) having a photographing function or a camera (for example, an interchangeable lens camera, a compact camera, a video camera, and a monitoring camera). The mechanical device MCHN in the camera may drive components of the optical device OPT for zooming, focusing, and shutter operation. The equipment EQP may be a transportation device (movable object) such as a vehicle, a ship, or an airplane. The equipment EQP may be a medical device such as an endoscope or a CT scanner.

The mechanical device MCHN in the transport device may be used as a mobile device. The equipment EQP as a transport device is suitable for transporting the photoelectric conversion device APR, or for assisting and/or automating operation (manipulation) by an imaging function. The processing device PRCS for assisting and/or automating driving (manipulation) may perform processing for operating the mechanical device MCHN as a mobile device based on information obtained by the photoelectric conversion device APR.

The photoelectric conversion device APR according to the present embodiment may provide a high value to a designer, a manufacturer, a seller, a purchaser, and/or a user thereof. Therefore, when the photoelectric conversion device APR is mounted on the equipment EQP, the value of the equipment EQP may also be increased. Therefore, in manufacturing and selling the equipment EQP, it is advantageous to determine the mounting of the photoelectric conversion device APR of the present embodiment on the equipment EQP in order to increase the value of the equipment EQP.

### Modified Embodiments

The present disclosure is not limited to the above-described embodiments, and various modifications are possible.

For example, an example in which a part of the configuration of any of the embodiments is added to another embodiment or an example in which a part of the configurations of any of the embodiments is substituted with some of the configurations of another embodiment is also an embodiment of the present disclosure.

Although one signal output line 16 is arranged in each column of the pixel array unit 10 in the above embodiment, a plurality of signal output lines 16 may be arranged in each column of the pixel array unit 10. In this case, the column circuit 42 may be provided for each of the plurality of signal output lines 16. By configuring the photoelectric conversion device in this manner, for example, it is possible to perform an operation of simultaneously reading out the pixels 12 of a plurality of rows.

The circuit configuration of the pixel 12 illustrated in FIG. 2 is an example and may be appropriately changed. For example, each pixel 12 may include two or more photoelectric conversion elements. In this case, a plurality of photoelectric conversion elements may share one FD node. Alternatively, a pupil division pixel in which a plurality of photoelectric conversion elements shares one microlens may be used so that a phase difference may be detected. In addition, the pixel 12 does not necessarily have to include the select transistor M4. The capacitance value of the node FD may be switchable.

The photoelectric conversion systems described in the fifth and sixth embodiments are examples of photoelectric conversion systems to which the photoelectric conversion device of the present disclosure may be applied, and the photoelectric conversion system to which the photoelectric conversion device of the present disclosure may be applied is not limited to the configuration illustrated in FIG. 11 and FIG. 12.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-084613, filed May 24, 2024, which is hereby incorporated by reference herein in its entirety.

What is claimed is:

1. A photoelectric conversion device comprising:
a pixel including a photoelectric conversion unit and an output unit configured to output a signal based on charge generated in the photoelectric conversion unit;
a signal output line connected to the pixel;
a level shift circuit connected to the signal output line and configured to perform a level-shift on an output signal of the pixel in a direction in which a voltage decreases; and
a signal processing circuit connected to the level shift circuit and including a capacitor to which an output signal of the level shift circuit is input,
wherein the signal processing circuit includes an oversampling-type analog-to-digital conversion circuit.

2. The photoelectric conversion device according to claim 1, wherein a second power supply voltage supplied to the signal processing circuit is lower than a first power supply voltage supplied to the output unit.

3. The photoelectric conversion device according to claim 1, wherein the signal processing circuit further includes a comparison circuit to which the output signal of the level shift circuit is input via the capacitor.

4. The photoelectric conversion device according to claim 1, wherein the signal processing circuit includes a sample-and-hold circuit including the capacitor.

5. The photoelectric conversion device according to claim 1, wherein the signal processing circuit includes a gain amplifier including the capacitor.

6. The photoelectric conversion device according to claim 1, wherein the signal processing circuit includes a switched capacitor circuit including the capacitor.

7. The photoelectric conversion device according to claim 1, wherein the level shift circuit is configured to supply a current to the signal processing circuit.

8. The photoelectric conversion device according to claim 1, wherein the level shift circuit includes a source follower circuit having an input node to which the output signal of the pixel is input and an output node connected to the signal processing circuit.

9. The photoelectric conversion device according to claim 8, wherein a back gate of a transistor constituting the source follower circuit is connected to a source of the transistor.

10. The photoelectric conversion device according to claim 1,
wherein the level shift circuit includes an operational amplifier having a pair of differential input nodes and an output node,
wherein one of the pair of differential input nodes of the operational amplifier is an input node to which the output signal of the pixel is input, and
wherein the other of the pair of differential input nodes and the output node of the operational amplifier are connected to the signal processing circuit.

11. The photoelectric conversion device according to claim 8, wherein the level shift circuit includes a first power supply node to which a third power supply voltage is supplied and a second power supply node to which a fourth power supply voltage is supplied.

12. The photoelectric conversion device according to claim 11, wherein the fourth power supply voltage is a ground voltage.

13. The photoelectric conversion device according to claim 11, wherein the fourth power supply voltage has a polarity opposite to that of the third power supply voltage.

14. The photoelectric conversion device according to claim 11, wherein a second power supply voltage supplied to the signal processing circuit and the third power supply voltage are the same.

15. The photoelectric conversion device according to claim 8, wherein the level shift circuit further includes a clamp circuit provided between the pixel and the input node.

16. The photoelectric conversion device according to claim 15, wherein the clamp circuit includes a second capacitor connected between the pixel and the input node, and a switch provided between the input node and a fifth power supply voltage.

17. The photoelectric conversion device according to claim 16, wherein the fifth power supply voltage is variable.

18. The photoelectric conversion device according to claim 8, further comprising: a current source connected to the signal output line and including a current source transistor configured to supply a bias current to the output unit of the pixel,
wherein the level shift circuit further includes a third capacitor connected between the current source transistor and the output node.

19. The photoelectric conversion device according to claim 1,
wherein the pixel comprises a plurality of pixels arranged to form a plurality of columns,
wherein the signal output line comprises a plurality of signal output lines, at least one of the plurality of output lines is provided for each of the plurality of columns, and each of the plurality signal output lines is connected to the pixels on the corresponding column, and
wherein the level shift circuit and the signal processing circuit are provided corresponding to each of the plurality of signal output lines.

20. A photoelectric conversion system comprising:
the photoelectric conversion device according to claim 1; and
a signal processing device configured to process a signal output from the photoelectric conversion device.

21. A movable object comprising:
the photoelectric conversion device according to claim 1;
a distance information acquisition unit configured to acquire distance information to an object from a parallax image based on a signal from the photoelectric conversion device; and
a control unit configured to control the movable object based on the distance information.

22. An equipment comprising:
the photoelectric conversion device according to claim 1; and
at least one of
an optical device corresponding to the photoelectric conversion device,
a control device configured to control the photoelectric conversion device,
a processing device configured to process a signal output from the photoelectric conversion device,
a mechanical device that is controlled based on information obtained by the photoelectric conversion device,
a display device configured to display information obtained by the photoelectric conversion device, and
a storage device configured to store information obtained by the photoelectric conversion device.
